(19) United States
(12) Patent Application Publication
(10) Pub. No.: US 2026/0169605 A1
(43) Pub. Date: Jun. 18, 2026

(54) DISPLAY APPARATUS DISPLAYING VIRTUAL INDICATOR AND CONTROLLING METHOD THEREOF

(71) Applicant: Samsung Electronics Co., LTD., Suwon-Si (KR)

(72) Inventors: Hyunseok KIM, Suwon-Si (KR); Kideok Seo, Suwon-Si (KR); Eunju Kim, Suwon-Si (KR)

(73) Assignee: Samsung Electronics Co., LTD., Suwon-si (KR)

(21) Appl. No.: 19/531,100

(22) Filed: Feb. 5, 2026

Related U.S. Application Data
(63) Continuation of application No. PCT/KR2024/008892, filed on Jun. 26, 2024.

(30) Foreign Application Priority Data
Aug. 16, 2023 (KR) 10-2023-0107166

(51) Int. Cl. G06F 3/04812; G06F 3/04845; G06F 3/14

(52) U.S. Cl. CPC G06F 3/04812; G06F 3/04845; G06F 3/1407

(57) ABSTRACT

A display apparatus includes: a display; a communication interface configured to communicate with a source device; memory storing instructions; and one or more processors, wherein the instructions, when executed by the one or more processors individually or collectively, cause the display apparatus to: obtain coordinate information corresponding to a movement of an input device; move an indicator on a screen of the display based on the obtained coordinate information; based on a control signal corresponding to a user input at the input device being received from the input device, control the communication interface to transmit coordinate information of the indicator and the control signal to the source device; and based on an image signal reflecting the user input being received from the source device through the communication interface, control the display to display the image signal.

### CROSS-REFERENCE TO RELATED APPLICATION(S)

This application is a continuation application of International Patent Application No. PCT/KR 2024/008892, filed on Jun. 26, 2024, which is based on and claims priority to Korean Patent Application No. 10-2023-0107166, filed on Aug. 16, 2023, the disclosures of which are incorporated herein by reference in their entireties.

### BACKGROUND

### 1. Field

The present disclosure relates to a display apparatus and a controlling method

thereof and more particularly, to a display apparatus that displays a virtual indicator and a controlling method thereof.

### 2. Description of Related Art

Recently, various home appliances have been developed and widely

distributed, and in particular, the development and distribution of display apparatuses and source devices have been more active than in any other field.

Consumers often have a plurality of display apparatuses and a plurality of source devices installed in their homes, and they express difficulties in controlling these devices.

For example, in order to individually control the display apparatus and the source device, an input device (or a control device) must be connected to the display apparatuses, and a separate input device must also be connected to the source devices, resulting in an increase in the number of input devices deployed within the home.

Moreover, the process of finding, among the input devices, the input device connected to the device the user intends to control (for example, a display apparatus or a source device) can cause inconvenience to the user.

There has been a demand for a method that, even when the device the user wants to control is changed, allows selective control of the display apparatus or source devices through a single input device, without the user having to find a specific input device (connected to the device to be controlled) among a plurality of input devices.

### SUMMARY

According to an aspect of the disclosure, a display apparatus includes: a display; a communication interface configured to communicate with a source device; memory storing instructions; and one or more processors, wherein the instructions, when executed by the one or more processors individually or collectively, cause the display apparatus to: obtain coordinate information corresponding to a movement of an input device; move an indicator on a screen of the display based on the obtained coordinate information; based on a control signal corresponding to a user input at the input device being received from the input device, control the communication interface to transmit coordinate information of the indicator and the control signal to the source device; and based on an image signal reflecting the user input being received from the source device through the communication interface, control the display to display the image signal.

The instructions, when executed by the one or more processors individually or collectively, cause the display apparatus to: select a first control mode or a second control mode based on a preset input received from the input device; based on the first control mode being selected, switch the indicator to a virtual indicator; move the virtual indicator based on the obtained coordinate information; based on the control signal being received, transmit coordinate information of the virtual indicator and the control signal to the source device; and control the display to display the image signal reflecting the user input.

The image signal may be transmitted from the source device to the display apparatus after the source device moves the indicator to correspond to the coordinate information of the indicator received from the display apparatus, and performs an operation corresponding to the control signal.

The instructions, when executed by the one or more processors individually or collectively, may cause the display apparatus to: select a first control mode or a second control mode based on a preset input received from the input device; based on the first control mode being selected, transmit a movement signal corresponding to the movement of the input device received from the input device to the source device; and based on the image signal reflecting the movement being received from the source device, control the display to display the image signal.

The image signal may be transmitted from the source device to the display apparatus after the source device obtains the coordinate information of the indicator based on the movement signal received from the display apparatus, and moves the indicator based on the coordinate information of the indicator.

The instructions, when executed by the one or more processors individually or collectively, may cause the display apparatus to: select a first control mode or a second control mode according to a preset input for the input device; based on the second control mode being selected according to the preset input, obtain the coordinate information based on a movement signal corresponding to the movement received from the input device; move the indicator based on the coordinate information; and based on the control signal being received, control the display to display a screen reflecting the user input by performing an operation corresponding to the coordinate information and the control signal.

In the first control mode, the source device may be controlled through the input device, in the second control mode, the display apparatus may be controlled through the input device, and the control signal may be transmitted from the input device to the display apparatus based on the user input for at least one of a button or a microphone of the input device.

The instructions, when executed by the one or more processors individually or collectively, may cause the display apparatus to: select a first control mode or a second control mode based on a preset input received from the input device; and based on the first control mode being selected, control the communication interface to transmit, to the source device, a movement signal corresponding to the movement and the control signal received from the input device, through a part of a bandwidth for receiving the image signal.

The instructions, when executed by the one or more processors individually or collectively, may cause the display apparatus to: based on a mode that controls the source device being selected through the input device, control the communication interface to transmit, to the source device, a movement signal corresponding to the movement and the control signal that are received from the input device, through a part of a bandwidth for receiving the image signal, and in the selected mode, a size of the image signal received from the source device corresponds to a remainder of the bandwidth.

The instructions, when executed by the one or more processors individually or collectively, may cause the display apparatus to: identify a content type corresponding to the image signal; and based on the content type being identified as a preset type, select a mode that controls the source device through the input device, and control the communication interface to transmit, to the source device, a movement signal corresponding to the movement and the control signal that are received from the input device.

According to an aspect of the disclosure, a method of controlling a display apparatus, includes: obtaining coordinate information corresponding to a movement of an input device; moving an indicator on a screen of a display of the display apparatus based on the obtained coordinate information; based on a control signal being corresponding to a user input at the input device being received from the input device, transmitting the coordinate information of the indicator and the control signal to a source device; and based on an image signal reflecting the user input being received from the source device, displaying the image signal.

The method may further include: selecting a first control mode or a second control mode according to a preset input received from the input device; and based on the first control mode being selected, switching the indicator to a virtual indicator, the moving the indicator includes moving the virtual indicator based on the obtained coordinate information, the transmitting to the source device includes, based on the control signal being received, transmitting the coordinate information of the virtual indicator and the control signal to the source device, and the displaying includes displaying the image signal reflecting the user input.

The image signal may be transmitted from the source device to the display apparatus after the source device moves the indicator to correspond to the coordinate information of the indicator received from the display apparatus, and performs an operation corresponding to the control signal.

The method may further include: selecting a first control mode or a second control mode based on a preset input received from the input device, the transmitting to the source device includes transmitting a movement signal corresponding to the movement received from the input device to the source device, and the displaying may include, based on the image signal reflecting the movement being received from the source device, displaying the image signal.

The image signal may be transmitted from the source device to the display apparatus after the source device obtains the coordinate information of the indicator based on the movement signal received from the display apparatus, and moves the indicator based on the coordinate information of the indicator.

The method may further include selecting a first control mode or a second control mode based on a preset input for the input device, the obtaining the coordinate information may include, based on the second control mode being selected, obtaining the coordinate information based on a movement signal corresponding to the movement of the input device received from the input device, the moving the indicator may include moving the indicator based on the coordinate information, and the displaying may include, based on the control signal being received, performing an operation corresponding to the coordinate information and the control signal and displaying a screen reflecting the user input.

In the first control mode, the source device may be controlled through the input device in the second control mode, the display apparatus may be controlled through the input device, and the control signal may be transmitted from the input device to the display apparatus based on the user input for at least one of a button or a microphone of the input device.

The method may further include selecting a first control mode or a second control mode based on a preset input received from the input device, and the transmitting may include, based on the first control mode being selected, transmitting, to the source device, a movement signal corresponding to the movement and the control signal received from the input device, through a part of a bandwidth for receiving the image signal.

The transmitting may include, based on a mode for controlling the source device being selected through the input device, transmitting, to the source device, a movement signal corresponding to the movement and the control signal received from the input device, through a part of a bandwidth for receiving the image signal, and in the selected mode, a size of the image signal received from the source device may correspond to a remainder of the bandwidth.

The method may further include: identifying a content type corresponding to the image signal; and based on the content type being identified as a preset type, selecting a mode for controlling the source device through the input device, the transmitting may include transmitting, to the source device, a movement signal corresponding to the movement and the control signal that are received from the input device.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a view provided to explain an input device that controls each of a display apparatus and a source device according to one or more embodiments;

FIG. 2 is a block diagram illustrating configuration of a display apparatus according to one or more embodiments;

FIG. 3 is a view provided to explain a display apparatus that displays an indicator according to one or more embodiments;

FIG. 4 is a view provided to explain a display apparatus that transmits coordinate information and a control signal according to one or more embodiments;

FIG. 5 is a view provided to explain a control mode selection user interface (UI) according to one or more embodiments;

FIG. 6 is a view provided to explain a display apparatus that transmits a movement signal according to one or more embodiments;

FIG. 7 is a view provided to explain a display apparatus that transmits a control signal according to one or more embodiments;

FIG. 8 is a view provided to explain a display apparatus that performs an operation corresponding to a control signal according to one or more embodiments;

FIG. 9 is a view provided to explain a connection between a display apparatus and a source device according to one or more embodiments;

FIG. 10 is a view provided to explain a display apparatus that receives an image signal from a source device and transmits coordinate information and a control signal to a source device according to one or more embodiments;

FIG. 11 is a view provided to explain a display apparatus that identifies a content type according to one or more embodiments; and

FIG. 12 is a flowchart provided to explain a method of controlling a display apparatus according to one or more embodiments.

### DETAILED DESCRIPTION

Hereinafter, embodiments of the present disclosure will be described in detail with reference to the accompanying drawings.

General terms that are currently widely used are selected as the terms used in the embodiments of the disclosure in consideration of their functions in the disclosure, but may be changed based on the intention of those skilled in the art or a judicial precedent, the emergence of a new technique, or the like. In addition, in a specific case, terms arbitrarily chosen by an applicant may exist, in which case, the meanings of such terms will be described in detail in the corresponding descriptions of the disclosure. Thus, the terms used in the embodiments of the disclosure need to be defined on the basis of the meanings of the terms and the overall contents throughout the disclosure rather than simple names of the terms.

Terms such as “comprising,” “having,” “including,” and “containing” are to be construed as open-ended terms (meaning “including, but not limited to,”) unless otherwise noted. The terms may specify the presence of stated features, numbers, steps, operations, elements, components or combinations thereof. The terms may not preclude the possibility of the presence or addition of one or more other features, numbers, steps, operations, elements, components, and/or combinations thereof. Recitation of ranges of values herein are merely intended to serve as a shorthand method of referring individually to each separate value falling within range, unless otherwise indicated herein and each separate value is incorporated into specification as if it were individually recited herein.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present.

Expressions such as “first”, “second”, “1st,” “2nd,” or the like, used in the disclosure may indicate various components regardless of sequence and/or importance of the components, will be used only in order to distinguish one component from the other components, and do not limit the corresponding components.

When it is described that an element (e.g., a first element) is referred to as being “(operatively or communicatively) coupled with/to” or “connected to” another element (e.g., a second element), it should be understood that it may be directly coupled with/to or connected to the other element, or they may be coupled with/to or connected to each other through an intervening element (e.g., a third element).

A term of a singular number may include its plural number unless explicitly indicated otherwise in the context.

Unless explicitly described or implicitly understood from one or more embodiments of the present disclosure, at least one of the components, elements, modules or units, or any nominalized verbs (collectively “components” in this paragraph) represented by a block or an equivalent indication in the drawings may be implemented or embodied by analog and/or digital circuits including one or more of a logic gate, an integrated circuit, a microprocessor, a microcontroller, a memory circuit, a passive electronic component, an active electronic component, an optical component, and the like. Alternatively or additionally, these components may be implemented or embodied by software including one or more instructions stored in an internal or external storage medium that is readable by at least one processor. For example, the at least one processor may invoke at least one of the one or more instructions stored in the storage medium, and execute it, with or without using one or more other components under the control of the at least one processor. This allows the at least one processor to perform at least one function or operation described above as being performed by each of the components according to the at least one instruction invoked. Here, the at least one processor may include a central processing unit (CPU), a graphic processing unit (GPU), another type of microprocessor, not being limited thereto. In other examples, the at least one processor may be implemented in application specific integrated circuit (ASIC) and field-programmable gate array (FPGA).

In this specification, a term ‘user’ may refer to a person using an electronic apparatus or a device using an electronic apparatus (e.g., an artificial intelligence electronic apparatus).

Hereinafter, one or more embodiments of the present disclosure will be described in greater detail with reference to the accompanying drawings.

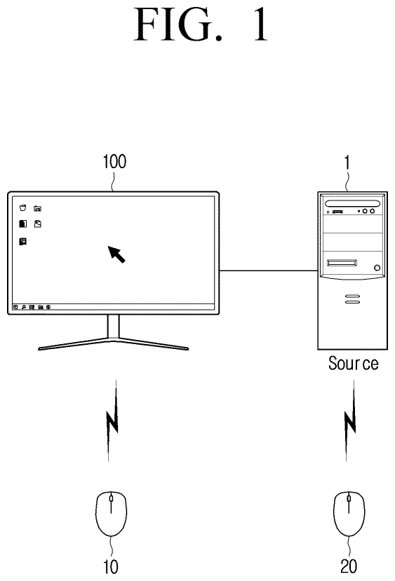

FIG. 1 is a view provided to explain an input device that controls each of a display apparatus and a source device according to one or more embodiments.

Referring to FIG. 1, a display apparatus 100 according to one or more embodiments may display content. The display apparatus 100 may be implemented as a TV, but is not limited thereto, and may be applied to any device having a display function, such as a video wall, a large format display (LFD), digital signage, a digital information display (DID), or a projector display. In addition, the display apparatus 100 may include various types of displays such as a liquid crystal display (LCD), an organic light-emitting diode (OLED), a liquid crystal on silicon (LCoS), a digital light processing (DLP), a quantum dot (QD) display panel, or quantum dot light-emitting diodes (QLED).

The present disclosure is not limited thereto, and the display apparatus 100 may be implemented as various types of output devices. For example, the display apparatus 100 may also be implemented as a user terminal device or an audio output device (e.g., a sound bar, a home theater system, a room speaker, a headphone, an earphone, etc.).

The display apparatus 100 according to one or more embodiments may receive an image signal (or content) from a source device 1, and output the received image signal. Here, the image signal may include a video signal and an audio signal. Hereinafter, for convenience of description, it will be assumed that the display apparatus 100 displays an image signal received from the source device 1.

The source device 1 according to one or more embodiments may be implemented as an electronic apparatus such as a set-top box, a cloud server, an over-the-top (OTT) media service server, a streaming service (e.g., Samsung Gaming Hub), a home automation control panel, a security control panel, a media box (e.g., Samsung HomeSync™, Apple TV™, or Google TV™), a game console (e.g., Xbox™, PlayStation™, or Switch™), an electronic dictionary, an electronic key, a camcorder, or an electronic frame. However, the source device 1 is not limited thereto, and may include at least one of a TV, a user terminal device, a tablet PC, a mobile phone, a videophone, an e-book reader, a desktop PC, a laptop PC, a netbook computer, a workstation, a server, a PDA, a PMP (portable multimedia player), an MP3 player, a medical device, a camera, a virtual reality (VR) apparatus, or a wearable device. Here, the wearable device may be implemented as at least one of an accessory type (e.g., a watch, a ring, a bracelet, an anklet, a necklace, glasses, contact lenses, or a head-mounted device (HMD)), a textile or clothing-integrated type (e.g., electronic clothing), a body-attachable type (e.g., a skin pad or tattoo), or a bio-implantable circuit.

The display apparatus 100 according to one or more embodiments may receive a user input through a first input device 10.

For example, the first input device 10 may be implemented as a mouse, a keyboard, a remote controller, a game pad, a camera, or a microphone to receive a user input. However, this is merely an example, and the first input device 10 is not limited thereto. For example, the input device 10 may be provided in the display apparatus 100, and may be implemented as a touch screen or the like that can perform both a display function and an input function.

When the first input device 10 is implemented as a mouse, a user input according to one or more embodiments may include a user input of moving the mouse, a user input with respect to a button provided on the mouse (e.g., clicking, double-clicking, dragging, and the like), etc.

In one example, according to the user input of moving the first input device 10, the first input device 10 may transmit a movement signal to the display apparatus 100, and according to the user input with respect to a button provided on the first input device 10, the first input device 10 may transmit a control signal to the display apparatus 100.

According to one or more embodiments, the display apparatus 100 may display an indicator. For example, the display apparatus 100 may receive a movement signal from the first input device 10 according to the movement of the first input device 10, and may obtain coordinate information based on the movement signal. Subsequently, the display apparatus 100 may move the indicator based on the coordinate information.

An indicator according to one or more embodiments may include a cursor, a pointer, and the like, which are merely examples for convenience of explanation, and the indicator may represent a position corresponding to the first input device 10 within a screen, and may include various types of signs (marks or symbols) that can be moved through the first input device 10 or can be used to select an object on the screen.

However, this is merely an example, and when the first input device 10 is implemented as a camera, the user input may include an output the camera (e.g., a face recognition image, an iris recognition image, and the like), and when the first input device 10 is implemented as a microphone, the user input may include a user voice and the like.

As illustrated in FIG. 1, the source device 1 may be connected to the display apparatus 100, and may transmit an image signal to the display apparatus 100.

In the related art, in order to control the source device 1, in addition to the first input device 10 that transmits a movement signal or a control signal to the display apparatus 100, a second input device 20 may be connected to the source device 1. For example, the second input device 20 may transmit a movement signal or a control signal to the source device 1 according to a user input for the second input device 20, and the source device 1 may transmit an image signal in which the user input is reflected to the display apparatus 100. However, it may be difficult to provide both the first input device 10 connected to the display apparatus 100 and the second input device 20 connected to the source device 1 (e.g., due to spatial constraints), and when a user desires to control the display apparatus 100, the user may have to find the first input device 10 connected to the display apparatus 100, and when the user desires to control the source device 1, the user may have to find the second input device 20 connected to the source device 1, thereby causing inconvenience to the user.

According to one or more embodiments, the display apparatus 100 may perform communication with the first input device 10, and the display apparatus 100 may perform an operation corresponding to a user input received from the first input device 10 or may transmit the user input received from the first input device 10 to the source device 1. Accordingly, both the display apparatus 100 and the source device 1 may be controlled by the first input device 10. Hereinafter, for convenience of explanation, the first input device 10 connected to the display apparatus 100 will be collectively referred to as the input device 10.

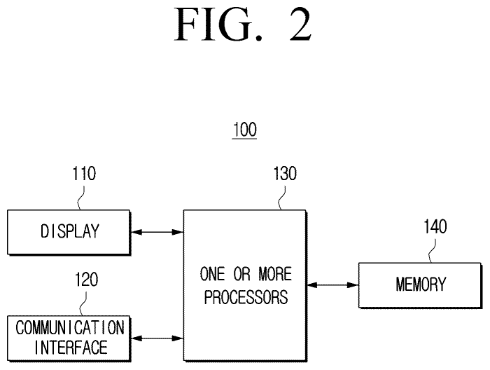

FIG. 2 is a block diagram illustrating configuration of a display apparatus according to one or more embodiments.

Referring to FIG. 2, the display apparatus 100 may include a display 110, a communication interface 120, one or more processors 130, and memory 140.

According to one or more embodiments, the display 110 may be implemented as various types of displays such as a liquid crystal display (LCD), an organic light-emitting diode (OLED), a liquid crystal on silicon (LCoS), a digital light processing (DLP), a quantum dot (QD) display panel, a quantum dot light-emitting diode (QLED), a micro light-emitting diode (μLED), a mini light-emitting diode (Mini LED), and the like. Meanwhile, the display 110 may also be implemented as a touch screen combined with a touch sensor, a flexible display, a rollable display, a three-dimensional (3D) display, or a display in which a plurality of display modules are physically connected.

The communication interface 120 according to one or more embodiments may include wired or wireless input/output interfaces (or input/output terminals) according to various standards. For example, the communication interface 120 may include various interfaces such as a high definition multimedia interface (HDMI), a mobile high-definition link (MHL), a universal serial bus (USB), a display port (DP), a Thunderbolt, a video graphics array (VGA) port, an RGB port, a D-subminiature (D-SUB), a digital visual interface (DVI), a Wi-Fi (Wireless LAN network) based on an access point (AP), a Bluetooth, a Zigbee, a wired/wireless local area network (LAN), a wide area network (WAN), an Ethernet, an IEEE 1394, an audio engineering society/European broadcasting union (AES/EBU), an optical, a coaxial, and the like.

The memory 140 may store various data used by at least one component (e.g., the processor 130) of the display apparatus 100. The various data may include, for example, software (e.g., computer executable instructions) and input data or output data for a command related thereto. The memory 130 may include a volatile memory and/or a non-volatile memory. The program stored in the memory may include, for example, an operating system (OS), middleware, or an application

According to one or more embodiments, the communication interface 120 may include an input/output interface, and may perform communication with the source device 1 through the input/output interface. For example, the display apparatus 100 may be connected to the source device 1 through the input/output interface of USB Type-C.

The one or more processors 130 according to one or more embodiments may control the display 110 to display an image signal received from the source device 1 through the communication interface 120.

The one or more processors 130 according to one or more embodiments may control the overall operations of the display apparatus 100.

According to one or more embodiments, the one or more processors 130 may be implemented as a digital signal processor (DSP), a microprocessor, or a timing controller (TCON) that processes digital signals. However, the present disclosure is not limited thereto, and the one or more processors 130 may include, or be defined as, one or more of a central processing unit (CPU), a micro controller unit (MCU), a micro processing unit (MPU), a controller, an application processor (AP), a communication processor (CP), an ARM processor, and an artificial intelligence (AI) processor. In addition, the processor 130 may also be implemented as a system on chip (SoC) or a large scale integration (LSI) with a built-in processing algorithm, or may be implemented in the form of a field programmable gate array (FPGA). The processor 130 may perform various functions by executing computer executable instructions stored in the memory 140.

According to one or more embodiments, the one or more processors 130 may receive a user input (e.g., a movement signal, a control signal, and the like) from the input device 10 through a wired or wireless communication interface (not shown).

According to one or more embodiments, the one or more processors 130 may perform an operation corresponding to a user input received from the input device 10, or may transmit the user input to the source device 1 through the communication interface 120 and receive an image signal reflecting the user input.

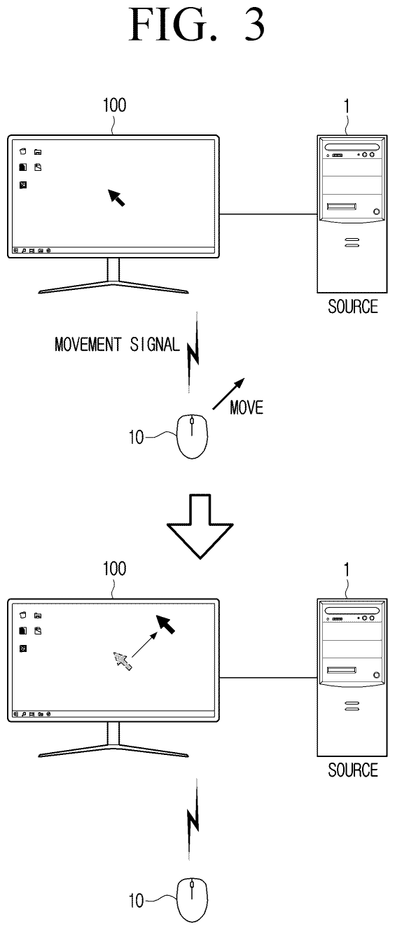

FIG. 3 is a view provided to explain a display apparatus that displays an indicator according to one or more embodiments.

Referring to FIG. 3, the one or more processors 130 may control the display 110 to display an image signal received from the source device 1.

The display apparatus 100 according to one or more embodiments may include a first control mode of controlling the source device 1 through the input device 10, and a second control mode of controlling the display apparatus 100 through the input device 10.

In one example, an indicator displayed by the display apparatus 100 in the first control mode may refer to an indicator for controlling the source device 1, and an indicator displayed by the display apparatus 100 in the second control mode may refer to another indicator for controlling the display apparatus 100.

When the display apparatus 100 is in the first control mode, the one or more processors 130 may display an indicator for controlling the source device 1. An indicator displayed by the one or more processors 130 in the first control mode may be a virtual indicator.

In one example, when the one or more processors 130 receive a movement signal corresponding to a movement of the input device 10 from the input device 10, the one or more processors 130 may obtain coordinate information based on the received movement signal. The one or more processors 130 according to one or more embodiments may move the virtual indicator based on the coordinate information.

According to one or more embodiments, an indicator included in an image signal transmitted by the source device 1 to the display apparatus 100 may not move, and the virtual indicator may move.

In the first control mode, a movement signal according to a movement of the input device 10 may be a user input to move the indicator included in the image signal transmitted by the source device 1, but the one or more processors 130 may not transmit the movement signal received from the input device 10 to the source device 1, and may obtain coordinate information based on the movement signal and move the virtual indicator based on the coordinate information.

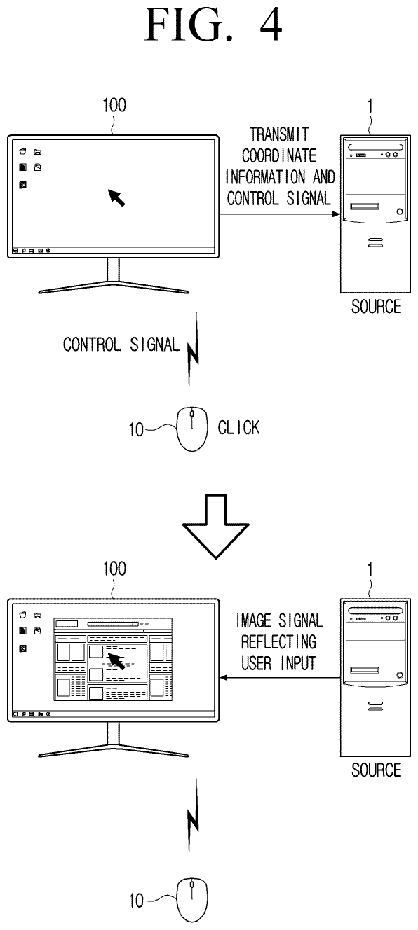

FIG. 4 is a view provided to explain a display apparatus that transmits coordinate information and a control signal according to one or more embodiments.

According to one or more embodiments, when a control signal is received according to a user input for the input device 10, the one or more processors 130 may control the communication interface 120 to transmit coordinate information of a virtual indicator and a control signal to the source device 1.

For example, the one or more processors 130 may move the virtual indicator according to a movement signal received from the input device 10. According to one or more embodiments, when a preset event (e.g., an event of receiving a control signal from the input device 10) occurs, the one or more processors 130 may transmit current coordinate information of the virtual indicator and the control signal received from the input device 10 to the source device 1. The control signal according to one or more embodiments may be a signal transmitted from the input device 10 to the display apparatus 100 according to a user input such as clicking, double-clicking, dragging, wheel scrolling, typing, or touching on the input device 10.

When receiving an image signal reflecting a user input from the source device 1, the one or more processors 130 may display the image signal received from the source device 1.

According to one or more embodiments, the image signal reflecting a user input may be an image signal transmitted from the source device 1 to the display apparatus 100 after moving the indicator to correspond to the coordinate information received from the display apparatus 100 and performing an operation corresponding to the control signal. For example, the operation corresponding to the control signal may include a user input such as clicking, double-clicking, dragging, wheel scrolling, typing, or touching on the input device 10.

According to one or more embodiments, in order to minimize user inconvenience caused by delays occurring during transmission and reception of signals between the display apparatus 100 and the source device 1, the display apparatus 100 may move the virtual indicator according to the movement signal while receiving the movement signal from the input device 10, and transmit the current coordinate information of the virtual indicator and the control signal to the source device 1 when the control signal is received.

According to one or more embodiments, since the current coordinate information of the virtual indicator and the control signal are transmitted to the source device 1 only when the control signal is received, and an image signal reflecting a user input is received, delay can be minimized compared to transmitting the movement signal to the source device 1 and receiving an image signal reflecting the movement of the indicator in real time according to the movement of the input device 10 from the source device 1.

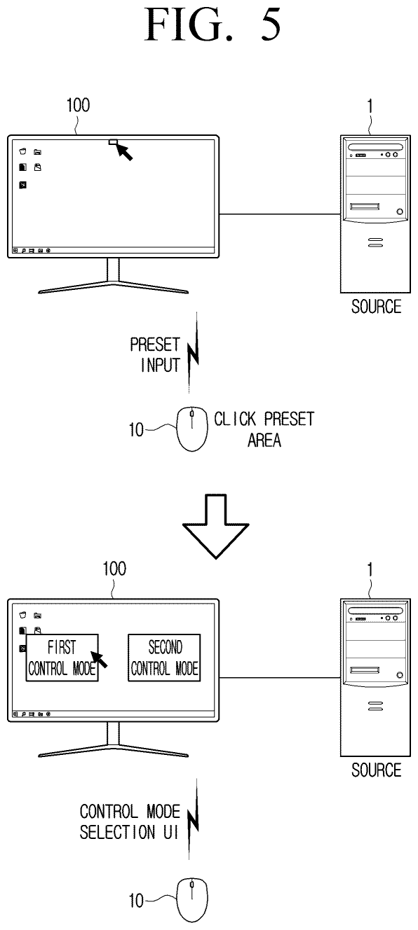

FIG. 5 is a view provided to explain a control mode selection user interface (UI) according to one or more embodiments.

Referring to FIG. 5, the one or more processors 130 may display a control mode selection UI according to a preset input for the input device 10.

For example, when a preset control signal is received from the input device 10 according to an input of clicking on a preset area within the screen (e.g., the center area at the top), a preset input (e.g., triple-clicking or a combination of some of a plurality of buttons provided on the input device 10), or a preset input in a preset area within the screen (e.g., wheel scrolling in the center area at the top), the one or more processors 130 may display the control mode selection UI.

For example, the one or more processors 130 may display the control mode selection UI through an OSD (On Screen Display) function.

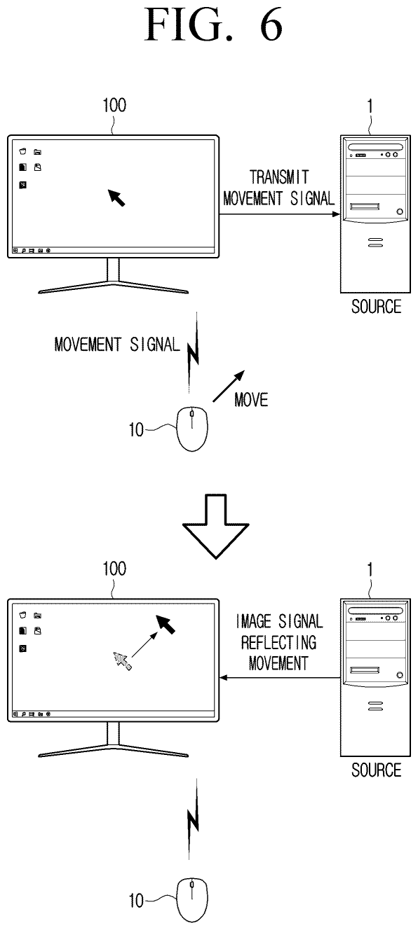

FIG. 6 is a view provided to explain a display apparatus that transmits a movement signal according to one or more embodiments.

In FIGS. 3 and 4, one or more embodiments are shown where the one or more processors 130 move a virtual indicator while receiving a movement signal from the input device 10, transmit current coordinate information of the virtual indicator and a control signal to the source device 1 when the control signal is received, and receive an image signal reflecting a user input. However, embodiments of the present disclosure are not limited thereto.

Referring to FIG. 6, when a movement signal is received from the input device 10 according to a movement of the input device 10 in the first control mode, the one or more processors 130 may transmit the movement signal to the source device 1.

According to one or more embodiments, when an image signal reflecting the movement is received from the source device 1, the one or more processors 130 may display the received image signal.

For example, the one or more processors 130 may move the indicator according to the movement signal received from the input device 10 even when a preset event (e.g., an event of receiving a control signal from the input device 10) does not occur.

For example, the one or more processors 130 may transmit the movement signal to the source device 1 and receive an image signal reflecting a real-time movement of the indicator according to a movement of the input device 10 from the source device 1.

For example, the image signal received from the source device 1 may be an image signal transmitted from the source device 1 to the display apparatus 100 after obtaining coordinate information based on the movement signal received from the display apparatus 100 and moving the indicator based on the obtained coordinate information.

For example, the one or more processors 130 may not display the virtual indicator, receive an image signal reflecting a real-time movement of the indicator from the source device 1, and display the received image signal.

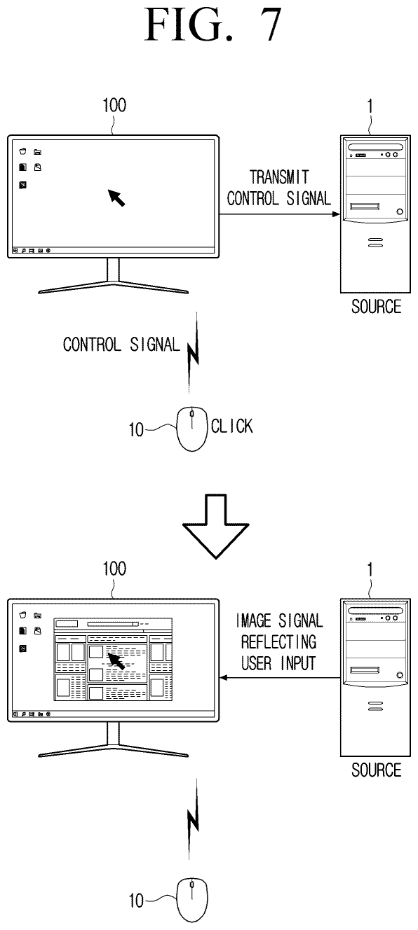

FIG. 7 is a view provided to explain a display apparatus that transmits a control signal according to one or more embodiments.

Following FIG. 6, the one or more processors 130 may transmit a control signal to the source device 1 when a preset event (e.g., an event of receiving a control signal from the input device 10) occurs.

As shown in FIG. 6, since the one or more processors 130 do not display a virtual indicator and receive an image signal reflecting a real-time movement of the indicator according to a movement of the input device 10 by transmitting a movement signal to the source device 1, when a control signal is received from the input device 10, the control signal may be transmitted to the source device 1.

According to one or more embodiments, the one or more processors 130 may receive an image signal reflecting a user input from the source device 1, and control the display 110 to display the received image signal.

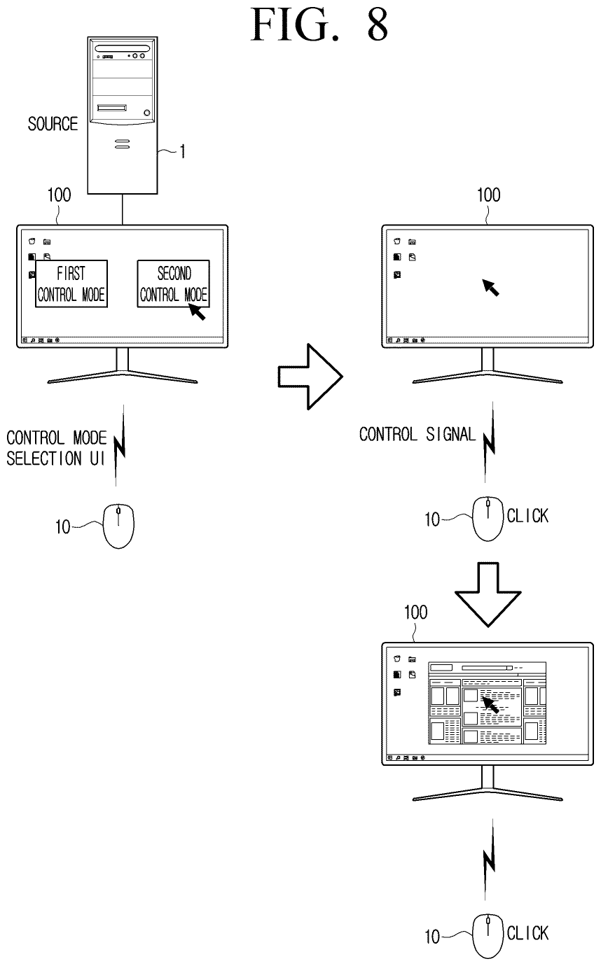

FIG. 8 is a view provided to explain a display apparatus that performs an operation corresponding to a control signal according to one or more embodiments.

For example, when the second control mode is selected in the control mode selection UI, the one or more processors 130 may display an indicator for controlling the display apparatus 100.

According to one or more embodiments, in the second control mode, when movement information is received from the input device 10 according to a movement of the input device 10, the one or more processors 130 may obtain coordinate information based on the movement information.

According to one or more embodiments, the one or more processors 130 may move the indicator based on the coordinate information.

Since the second control mode is a mode for controlling the display apparatus 100 through the input device 10, the one or more processors 130 may not display a virtual indicator, but may display an indicator for controlling the display apparatus 100.

According to one or more embodiments, when a control signal is received from the input device 10 according to a user input for the input device 10, the one or more processors 130 may perform an operation corresponding to the coordinate information and the control signal, and display a screen reflecting the user input.

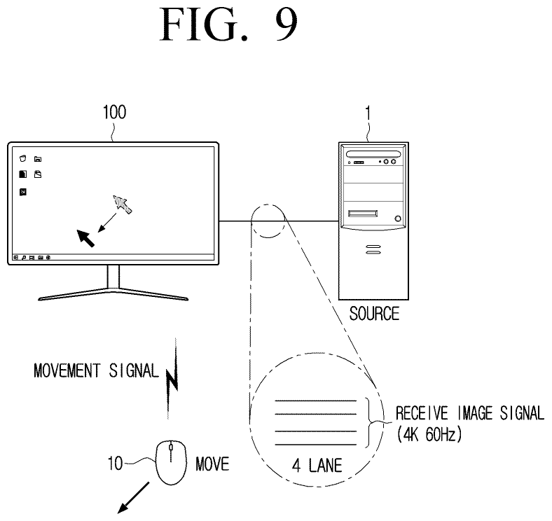

FIG. 9 is a view provided to explain a connection between a display apparatus and a source device according to one or more embodiments.

According to one or more embodiments, the display apparatus 100 may be connected to the source device 1 through an input/output interface of USB Type-C.

According to one or more embodiments, the display apparatus 100 may receive an image signal from the source device 1 using four lanes of USB Type-C.

For example, in accordance with DisplayPort Alternate Mode (or DP Alt Mode), the display apparatus 100 may receive an image signal from the source device 1 through one, two, or four lanes of USB Type-C.

For example, the display apparatus 100 may receive an image signal having a resolution of 4 K (3840×2160) and a refresh rate of 60 Hz from the source device 1 using four lanes of USB Type-C.

According to one or more embodiments, when the first control mode is selected, the one or more processors 130 may transmit a movement signal and a control signal to the source device 1 through a part of a bandwidth for receiving an image signal.

For example, when the display apparatus 100 receives an image signal from the source device 1 through two lanes in DisplayPort Alternate Mode, the one or more processors 130 may transmit a movement signal and a control signal to the source device 1 through two lanes.

For example, the display apparatus 100 may receive an image signal having a resolution of 4 K (3840×2160) and a refresh rate of 30 Hz from the source device 1 using two lanes of USB Type-C.

For example, a DP signal may be transmitted at a transfer rate of 20 Gbps per lane, and in the first control mode, the one or more processors 130 may receive a DP signal (or image signal) at a transfer rate of 40 Gbps through two lanes, and may transmit and receive various signals (e.g., a movement signal, a control signal, etc.) and various data to and from the source device 1 through the remaining two lanes at a transfer rate of 40 Gbps. Meanwhile, the specific numerical values described above are merely exemplary for convenience of explanation, and are not limited thereto.

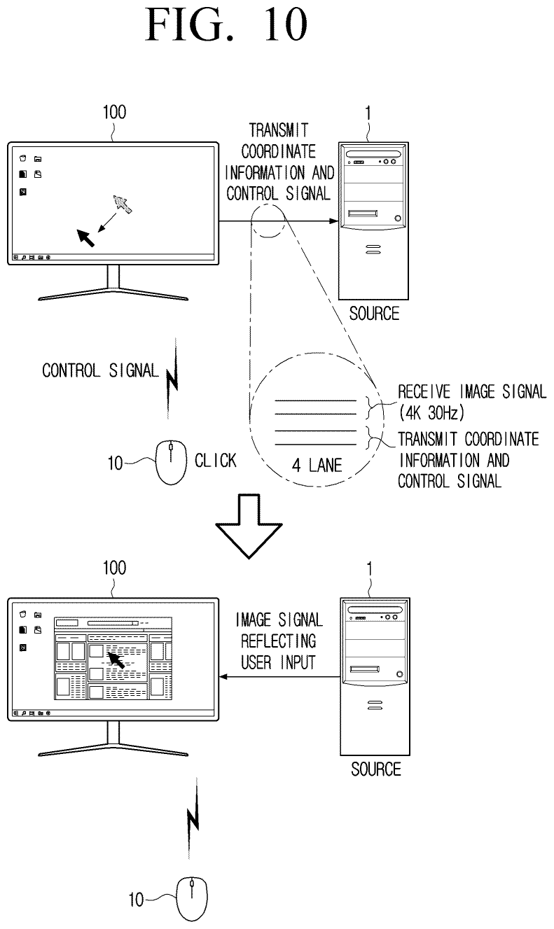

FIG. 10 is a view provided to explain a display apparatus that receives an image signal from a source device and transmits coordinate information and a control signal to a source device according to one or more embodiments.

Referring to FIG. 10, in addition to the first control mode and the second control mode described above, the display apparatus 100 may operate in either a high resolution mode or a high speed mode. The name of each mode is merely an example for convenience of explanation, and is not limited thereto.

According to one or more embodiments, when the display apparatus 100 operates in the high resolution mode, the one or more processors 130 may receive an image signal through the entire bandwidth of the input/output interface. For example, when the display apparatus 100 is connected to the source device 1 through the input/output interface of USB Type-C, the display apparatus 100 may receive an image signal from the source device 1 using four lanes of USB Type-C.

According to one or more embodiments, in the high resolution mode, the source device 1 may not be controlled through the input device 10 connected to the display apparatus 100, or a movement signal and a control signal may be transmitted to the source device 1 through the input/output interface (e.g., USB Type-C) to which the display apparatus 100 and the source device 1 are connected.

For example, in the high resolution mode of the display apparatus 100, one or more processors 130 may be unable to transmit the movement signal and the control signal received from the input device 10 to the source device 1 through the input/output interface (e.g., USB Type-C) to which the display apparatus 100 and the source device 1 are connected.

According to one or more embodiments, when the display apparatus 100 operates in the high speed mode, one or more processors 130 may transmit the movement signal and the control signal received from the input device 10 to the source device 1 through a part of the bandwidth of the input/output interface.

In addition, in the high speed mode of the display apparatus 100, the size of the image signal received from the source device 1 may correspond to the remaining bandwidth. For example, in the high resolution mode of the display apparatus 100, the one or more processors 130 may receive an image signal of high resolution and high refresh rate (e.g., 4K, 60 Hz) from the source device 1, and in the high speed mode of the display apparatus 100, the one or more processors 130 may receive an image signal of relatively low resolution and low refresh rate (e.g., 4K, 30 Hz, or FHD (1920×1080), 60 Hz) from the source device 1. However, the specific numerical values mentioned above are merely examples for convenience of explanation and are not limited thereto.

According to one or more embodiments, the one or more processors 130 may display a UI for selecting either the high resolution mode or the high speed mode, similar to the control mode selection UI shown in FIG. 5.

According to one or more embodiments, when the high resolution mode is selected through the UI, the display apparatus 100 may operate in the high resolution mode and receive an image signal through the entire bandwidth of the input/output interface.

According to one or more embodiments, when the high speed mode is selected, the display apparatus 100 may operate in the high speed mode, transmit a movement signal and a control signal received from the input device 10 to the source device 1 through a part of the bandwidth, and receive an image signal from the source device 1 through the remaining bandwidth.

According to one or more embodiments, the operation of the display apparatus 100 in the high speed mode may be the same as the mode in which the source device 1 is controlled through the input device 10, that is, the first control mode shown in FIGS. 3 and 4 or the first control mode shown in FIGS. 6 and 7.

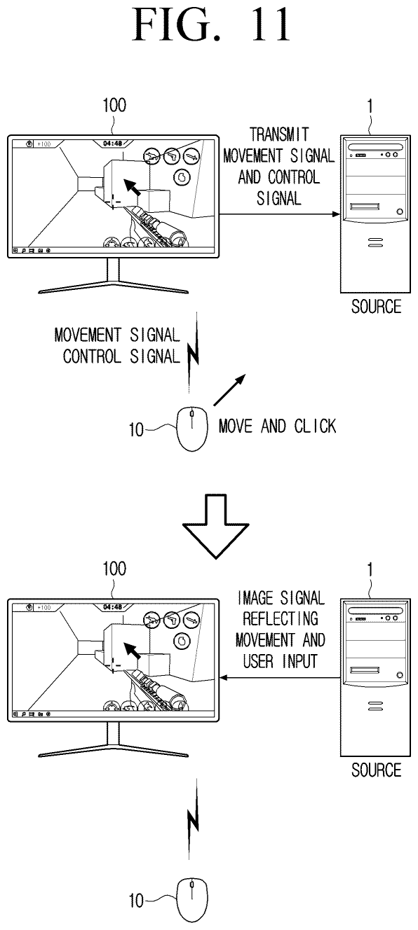

FIG. 11 is a view provided to explain a display apparatus that identifies a content type according to one or more embodiments.

Referring to FIG. 11, the one or more processors 130 may identify a content type corresponding to an image signal received from the source device 1.

For example, one or more processors 130 may select a high resolution mode or a high speed mode based on the identified content type.

The content type may include, for example, movie content, game content, concert content, streaming content, or image content, etc.

According to one or more embodiments, when the identified content type corresponds to movie content, concert content, or the like, the one or more processors 130 may select the high resolution mode.

According to one or more embodiments, the one or more processors 130 may receive an image signal from the source device 1 through the entire bandwidth of the input/output interface in the high resolution mode.

For example, since movie content, concert content, and the like need to be output in high resolution for user immersion, etc. the one or more processors 130 may select the high resolution mode and receive an image signal from the source device 1 through the entire bandwidth of the input/output interface.

According to one or more embodiments, when the identified content type corresponds to game content or the like, the one or more processors 130 may select the high speed mode.

According to one or more embodiments, the one or more processors 130 may transmit a movement signal and a control signal received from the input device 10 to the source device 1 through a part of the bandwidth of the input/output interface in the high speed mode, and receive an image signal from the source device 1 through the remaining bandwidth.

For example, in game content, it is necessary to transmit a user input for the input device 10 to the source device 1, and due to the response speed of the game character within the game content, etc., it is necessary to minimize delay occurring during signal transmission and reception between the display apparatus 100 and the source device 1.

According to one or more embodiments, while receiving a movement signal in the high speed mode, the one or more processors 130 may move a virtual indicator, and upon receiving a control signal, transmit the current coordinate information of the virtual indicator along with the control signal to the source device 1 to receive an image signal that reflect the user input.

Referring back to FIG. 2, the display apparatus 100 may further include memory and wired/wireless communication interface.

The memory according to one or more embodiments may store data necessary for various embodiments of the present disclosure. The memory may be implemented as embedded memory within the display apparatus 100 or as detachable memory that can be attached to or detached from the display apparatus 100 depending on the purpose of data storage.

For example, data for driving the display apparatus 100 may be stored in memory embedded in the display apparatus 100, and data for extended functions of the display apparatus 100 may be stored in detachable memory of the display apparatus 100. Meanwhile, the memory embedded in the display apparatus 100 may be implemented as at least one of a volatile memory (e.g. a dynamic RAM (DRAM), a static RAM (SRAM), or a synchronous dynamic RAM (SDRAM)), or a non-volatile memory (e.g., a one-time programmable ROM (OTPROM), a programmable ROM (PROM), an erasable and programmable ROM (EPROM), an electrically erasable and programmable ROM (EEPROM), a mask ROM, a flash ROM, a flash memory (e.g. a NAND flash or a NOR flash), a hard drive, or a solid state drive (SSD)). In addition, the memory detachable from the display apparatus 100 may be implemented in the form of a memory card (e.g., a compact flash (CF), a secure digital (SD), a micro secure digital (Micro-SD), a mini secure digital (Mini-SD), an extreme digital (xD), or a multi-media card (MMC)), an external memory connectable to a USB port (e.g., a USB memory), or the like.

According to one or more embodiments, the memory may store at least one instruction for controlling the display apparatus 100 or a computer program including instructions.

According to one or more embodiments, the wired/wireless communication interface may include a wired or wireless input/output interface (or input/output terminal) according to various standards. For example, the wired/wireless communication interface may include various interfaces such as High Definition Multimedia Interface (HDMI), Mobile High-Definition Link (MHL), Universal Serial Bus (USB), Display Port (DP), Thunderbolt, Video Graphics Array (VGA) port, Red Green Blue (RGB) port, D-subminiature (D-SUB), Digital Visual Interface (DVI), AP-based Wireless Fidelity (Wi-Fi, Wireless LAN network), Bluetooth, Zigbee, wired/wireless Local Area Network (LAN), Wide Area Network (WAN), Ethernet, Institute of Electrical and Electronics Engineers 1394 (IEEE 1394), Audio Engineering Society/European Broadcasting Union (AES/EBU), optical, and coaxial.

According to one or more embodiments, the input device 10 may be connected (or paired) to the display apparatus 100 through the wired/wireless communication interface.

The one or more processors 130 may receive a movement signal or a control signal from the connected input device 10. For example, the one or more processors 130 may perform wireless communication with the input device 10 (e.g., via Bluetooth pairing) to receive a movement signal and a control signal, or perform wired communication with the input device 10 (e.g., via USB port) to receive a movement signal and a control signal.

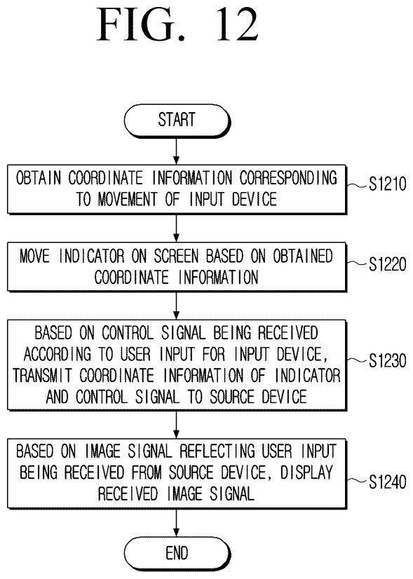

FIG. 12 is a flowchart provided to explain a method of controlling a display apparatus according to one or more embodiments.

A method of controlling a display apparatus according to one or more embodiments of the present disclosure first includes obtaining coordinate information corresponding to a movement of an input device (S1210).

Based on the obtained coordinate information, an indicator on the screen is moved (S1220).

When a control signal is received according to a user input on the input device, the coordinate information of the indicator and the control signal are transmitted to a source device (S1230).

When an image signal reflecting the user input is received from the source device, the received image signal is displayed (S1240).

According to one or more embodiments, the method may further include selecting one of a first control mode or a second control mode according to a preset input for the input device, and when the first control mode is selected according to a preset input, switching the indicator to a virtual indicator, and the step S1220 of moving the indicator may include moving the virtual indicator based on the obtained coordinate information. The step S1230 of transmitting to the source device may include transmitting the coordinate information of the virtual indicator and the control signal to the source device when the control signal is received, and the step S1240 of displaying may include displaying an image signal reflecting the user input.

The image signal may be an image signal transmitted to the display apparatus after the source device obtains coordinate information based on a movement signal received from the display apparatus, moves the indicator based on the obtained coordinate information, and then transmits the image signal to the display apparatus.

The method according to one or more embodiments may further include selecting one of a first control mode or a second control mode according to a preset input for the input device, and the step S1210 of obtaining coordinate information may include, when the second control mode is selected according to a preset input, obtaining coordinate information based on a movement signal received from the input device according to a movement. The step S1220 of moving the indicator may include moving the indicator based on the obtained coordinate information. The step S1240 of displaying may include, when a control signal is received, performing an operation corresponding to the coordinate information and the control signal and displaying a screen reflecting the user input.

The first control mode according to one or more embodiments is a mode in which the source device is controlled through the input device, the second control mode is a mode in which the display apparatus is controlled through the input device, and the control signal may be a control signal transmitted from the input device to the display apparatus according to a user input on at least one of a button or a microphone provided in the input device.

The method according to one or more embodiments may further include selecting one of the first control mode or the second control mode according to a preset input for the input device, and the step S1230 of transmitting may include, when the first control mode is selected according to a preset input, transmitting a movement signal and a control signal received from the input device according to a movement to the source device through a part of a bandwidth for receiving an image signal.

The method according to one or more embodiments may further include selecting a mode for controlling the source device through the input device, and the step S1230 of transmitting may include, when the mode for controlling the source device is selected through the input device, transmitting a movement signal and a control signal received from the input device according to a movement to the source device through a part of a bandwidth for receiving an image signal, and the size of the image signal received from the source device in the selected mode may correspond to the remaining bandwidth.

The method according to one or more embodiments may further include identifying a content type corresponding to the image signal, and when the identified content type is a preset type, selecting a mode for controlling the source device through the input device, the step S1230 of transmitting may include transmitting the movement signal and the control signal received from the input device according to a movement to the source device, and the step S1240 of displaying may include receiving an image signal from the source device reflecting the movement and the user input.

However, various embodiments of the present disclosure may be applied not only to a display apparatus but also to various types of electronic apparatuses including a display function.

The various embodiments described above may be implemented within a recording medium readable by a computer or a similar device using software, hardware, or a combination thereof. In some cases, the embodiments described in this specification may be implemented by a processor itself. According to a software implementation, embodiments such as the procedures and functions described in this specification may be implemented as separate software modules. Each of the software modules may perform one or more functions and operations described in this specification.

Computer instructions for performing the processing operations of the display apparatus 100 according to the various embodiments described above may be stored in a non-transitory computer-readable medium. The computer instructions stored in such a non-transitory computer-readable medium cause a specific device to perform the processing operations of the display apparatus 100 according to the various embodiments described above when executed by a processor of the specific device.

The non-transitory computer-readable medium refers to a medium that stores data semi-permanently and is readable by a device, rather than a medium that stores data for a short period, such as registers, caches, or memories. Specific examples of the non-transitory computer-readable medium may include CD, DVD, hard disk, Blu-ray disc, USB, memory card, and ROM.

Although example embodiments of the present disclosure have been shown and described above, the disclosure is not limited to the specific embodiments described above, and various modifications may be made by one of ordinary skill in the art without departing from the spirit of the disclosure as claimed in the claims, and such modifications are not to be understood in isolation from the technical ideas or prospect of the disclosure.

What is claimed is:

1. A display apparatus comprising:
a display;
a communication interface configured to communicate with a source device;
memory storing instructions; and
one or more processors,
wherein the instructions, when executed by the one or more processors individually or collectively, cause the display apparatus to:
obtain coordinate information corresponding to a movement of an input device;
move an indicator on a screen of the display based on the obtained coordinate information;
based on a control signal corresponding to a user input at the input device being received from the input device, control the communication interface to transmit coordinate information of the indicator and the control signal to the source device; and
based on an image signal reflecting the user input being received from the source device through the communication interface, control the display to display the image signal.

2. The display apparatus of claim 1, wherein the instructions, when executed by the one or more processors individually or collectively, cause the display apparatus to:
select a first control mode or a second control mode based on a preset input received from the input device;
based on the first control mode being selected, switch the indicator to a virtual indicator;
move the virtual indicator based on the obtained coordinate information;
based on the control signal being received, transmit coordinate information of the virtual indicator and the control signal to the source device; and
control the display to display the image signal reflecting the user input.

3. The display apparatus of claim 2, wherein the image signal is transmitted from the source device to the display apparatus after the source device moves the indicator to correspond to the coordinate information of the indicator received from the display apparatus, and performs an operation corresponding to the control signal.

4. The display apparatus of claim 1, wherein the instructions, when executed by the one or more processors individually or collectively, cause the display apparatus to:
select a first control mode or a second control mode based on a preset input received from the input device;
based on the first control mode being selected, transmit a movement signal corresponding to the movement of the input device received from the input device to the source device; and
based on the image signal reflecting the movement being received from the source device, control the display to display the image signal.

5. The display apparatus of claim 4, wherein the image signal is transmitted from the source device to the display apparatus after the source device obtains the coordinate information of the indicator based on the movement signal received from the display apparatus, and moves the indicator based on the coordinate information of the indicator.

6. The display apparatus of claim 1, wherein the instructions, when executed by the one or more processors individually or collectively, cause the display apparatus to:
select a first control mode or a second control mode according to a preset input for the input device;
based on the second control mode being selected according to the preset input, obtain the coordinate information based on a movement signal corresponding to the movement received from the input device;
move the indicator based on the coordinate information; and
based on the control signal being received, control the display to display a screen reflecting the user input by performing an operation corresponding to the coordinate information and the control signal.

7. The display apparatus of claim 6, wherein in the first control mode, the source device is controlled through the input device,
wherein in the second control mode, the display apparatus is controlled through the input device, and
wherein the control signal is transmitted from the input device to the display apparatus based on the user input for at least one of a button or a microphone of the input device.

8. The display apparatus of claim 1, wherein the instructions, when executed by the one or more processors individually or collectively, cause the display apparatus to:
select a first control mode or a second control mode based on a preset input received from the input device; and
based on the first control mode being selected, control the communication interface to transmit, to the source device, a movement signal corresponding to the movement and the control signal received from the input device, through a part of a bandwidth for receiving the image signal.

9. The display apparatus of claim 1, wherein the instructions, when executed by the one or more processors individually or collectively, cause the display apparatus to:
based on a mode that controls the source device being selected through the input device, control the communication interface to transmit, to the source device, a movement signal corresponding to the movement and the control signal that are received from the input device, through a part of a bandwidth for receiving the image signal, and
wherein in the selected mode, a size of the image signal received from the source device corresponds to a remainder of the bandwidth.

10. The display apparatus of claim 1, wherein the instructions, when executed by the one or more processors individually or collectively, cause the display apparatus to:
identify a content type corresponding to the image signal; and
based on the content type being identified as a preset type, select a mode that controls the source device through the input device, and control the communication interface to transmit, to the source device, a movement signal corresponding to the movement and the control signal that are received from the input device.

11. A method of controlling a display apparatus, the method comprising:
obtaining coordinate information corresponding to a movement of an input device;
moving an indicator on a screen of a display of the display apparatus based on the obtained coordinate information;
based on a control signal being corresponding to a user input at the input device being received from the input device, transmitting the coordinate information of the indicator and the control signal to a source device; and
based on an image signal reflecting the user input being received from the source device, displaying the image signal.

12. The method of claim 11, further comprising:
selecting a first control mode or a second control mode according to a preset input received from the input device; and
based on the first control mode being selected, switching the indicator to a virtual indicator,
wherein the moving the indicator comprises moving the virtual indicator based on the obtained coordinate information,
wherein the transmitting to the source device comprises, based on the control signal being received, transmitting the coordinate information of the virtual indicator and the control signal to the source device, and
wherein the displaying comprises displaying the image signal reflecting the user input.

13. The method of claim 12, wherein the image signal is transmitted from the source device to the display apparatus after the source device moves the indicator to correspond to the coordinate information of the indicator received from the display apparatus, and performs an operation corresponding to the control signal.

14. The method of claim 11, further comprising:
selecting a first control mode or a second control mode based on a preset input received from the input device,
wherein the transmitting to the source device comprises transmitting a movement signal corresponding to the movement received from the input device to the source device, and
wherein the displaying comprises, based on the image signal reflecting the movement being received from the source device, displaying the image signal.

15. The method of claim 14, wherein the image signal is transmitted from the source device to the display apparatus after the source device obtains the coordinate information of the indicator based on the movement signal received from the display apparatus, and moves the indicator based on the coordinate information of the indicator.

16. The method of claim 11, further comprising selecting a first control mode or a second control mode based on a preset input for the input device,
wherein the obtaining the coordinate information comprises, based on the second control mode being selected, obtaining the coordinate information based on a movement signal corresponding to the movement of the input device received from the input device,
wherein the moving the indicator comprise moving the indicator based on the coordinate information, and
wherein the displaying comprises, based on the control signal being received, performing an operation corresponding to the coordinate information and the control signal and displaying a screen reflecting the user input.

17. The method of claim 16, wherein in the first control mode, the source device is controlled through the input device,
wherein in the second control mode, the display apparatus is controlled through the input device, and
wherein the control signal is transmitted from the input device to the display apparatus based on the user input for at least one of a button or a microphone of the input device.

18. The method of claim 11, further comprising:
selecting a first control mode or a second control mode based on a preset input received from the input device, and
wherein the transmitting comprises, based on the first control mode being selected, transmitting, to the source device, a movement signal corresponding to the movement and the control signal received from the input device, through a part of a bandwidth for receiving the image signal.

19. The method of claim 11, wherein the transmitting comprises, based on a mode for controlling the source device being selected through the input device, transmitting, to the source device, a movement signal corresponding to the movement and the control signal received from the input device, through a part of a bandwidth for receiving the image signal, and
wherein in the selected mode, a size of the image signal received from the source device corresponds to a remainder of the bandwidth.

20. The method of claim 11, further comprising:
identifying a content type corresponding to the image signal; and
based on the content type being identified as a preset type, selecting a mode for controlling the source device through the input device,
wherein the transmitting comprises transmitting, to the source device, a movement signal corresponding to the movement and the control signal that are received from the input device.
